(19) United States
(12) Patent Application Publication
(10) Pub. No.: US 2023/0214114 A1
(43) Pub. Date: Jul. 6, 2023

(54) DATA RETENTION TIME CALCULATION METHOD, APPARATUS, AND DEVICE

(71) Applicant: GUANGDONG INSPUR SMART COMPUTING TECHNOLOGY CO., LTD., Guangzhou, Guangdong (CN)

(72) Inventors: Yubin LV, Guangzhou, Guangdong (CN); Yong QI, Guangzhou, Guangdong (CN)

(21) Appl. No.: 17/927,727

(22) PCT Filed: Jan. 25, 2021
(86) PCT No.: PCT/CN2021/073485

§ 371 Date: Nov. 24, 2022

(30) Foreign Application Priority Data
May 28, 2020 (CN) 202010470817.0

(51) Int. Cl. G06F 3/06

(52) U.S. Cl. CPC G06F 3/0604; G06F 3/0653; G06F 3/0679

(57) ABSTRACT

A data retention time calculation method, apparatus, and device. said method includes: acquiring a temperature value of a solid state disk(SSD) in a past preset duration; according to the temperature value and a preset temperature acceleration model, calculating an acceleration factor corresponding to the temperature value; taking a product of the preset duration and the acceleration factor as a life cycle increment in the past preset duration; and adding the life cycle increment to a retention time of target data, so as to update a storage area of the target data in view of a preset life cycle.

### CROSS-REFERENCE TO RELATED APPLICATION

The present disclosure claims the priority of the Chinese patent application filed on May 28^{th}, 2020 before the CNIPA, China National Intellectual Property Administration with the application number of 202010470817.0 and the title of “DATA RETENTION TIME CALCULATION METHOD, APPARATUS, AND DEVICE”, which is incorporated herein in its entirety by reference.

### FIELD

The present disclosure relates to the field of data storage and, more particularly, to a method for calculating a data retention time, and an apparatus and device for calculating a data retention time.

### BACKGROUND

SSD (Solid State Disk) is a common storage device now. In an SSD, if data is continuously stored in a fixed storage area for too long, then the data will report errors. To prevent this from happening, in the prior art, the storage area of the data is updated before the data is continuously stored for a retention time that reaches a preset life cycle, but influential factors on the data retention time do not only include the storage time. However, in the prior art, since only the influence of the storage time on the retention time is considered, the retention time derived from the calculation is not accurate, and there may be a situation where the retention time does not reach a preset life cycle but data is erroneous, resulting in poor security of data storage.

Therefore, for those skilled in the art, a solution to the above-mentioned technical problem is desirable now.

### SUMMARY

It is an object of the present disclosure to provide a method for calculating a data retention time, which may avoid the situation where the retention time does not reach a preset life cycle but the data is erroneous, and improve the security of data storage. Another object of the present disclosure is to provide an apparatus and device for calculating data retention time, which may avoid the situation that the retention time does not reach the preset life cycle but the data is erroneous, and improve the security of data storage.

To solve the above technical problem, the present disclosure provides a method for calculating a data retention time, including:
acquiring a temperature value of a solid state disk SSD within a preset time period in the past;
calculating an acceleration factor corresponding to the temperature value according to the temperature value and a preset temperature acceleration model;
taking a product of the preset time period and the acceleration factor as a life cycle increment within the preset time period in the past; and
adding the life cycle increment to a retention time of target data so as to perform a storage area update on the target data in combination with a preset life cycle.

In an embodiment of the present disclosure, acquiring the temperature value of the solid state disk SSD within the preset time period in the past is:
acquiring the temperature value of the solid state disk SSD within the preset time period in the past in an SSD power-on state; and
before adding the life cycle increment to the retention time of target data, the method for calculating the data retention time further including:
   acquiring a power-off time period of the solid state disk SSD; and
   taking a product of the power-off time period and a preset acceleration factor as a life cycle increment within the power-off time period.

In an embodiment of the present disclosure, calculating the acceleration factor corresponding to the temperature value according to the temperature value and a preset temperature acceleration model is:

$${T}_{A F} = \text{exp} {\left[\frac{{E}_{\text{a}}}{\text{k}} \left(\frac{1}{{T}_{\text{normal}}} - \frac{1}{{T}_{\text{stress}}}\right)\right]}_{;}$$

wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

In an embodiment of the present disclosure, acquiring the power-off time period of the solid state disk SSD includes:
recording a power-off time when the solid state disk SSD is powered off;
recording a power-on time when the solid state disk SSD is powered on; and
calculating the power-off time period of the solid state disk SSD according to the power-on time and the power-off time.

In an embodiment of the present disclosure, acquiring the temperature value of the solid state disk SSD within the preset time period in the past is:

Taking a temperature value collected presently of the solid state disk SSD as the temperature value of the solid state disk SSD within the past preset time period.

In an embodiment of the present disclosure, after adding the life cycle increment to the retention time of target data, the method for calculating a data retention time further including:
determining whether a value of the preset life cycle minus the retention time is less than a preset safety value;
under a condition that the value of the preset life cycle minus the retention time is less than the preset safety value, executing a moving action on the target data and clearing the retention time of the target data; and
under a condition that the value of the preset life cycle minus the retention time is not less than the preset safety value, executing the step of acquiring the temperature value of the solid state disk SSD within the past preset time period.

To solve the above technical problem, the present disclosure also provides an apparatus for calculating a data retention time, including:
a first acquisition module configured for acquiring a temperature value of a solid state disk SSD within a preset time period in the past;
a first calculation module configured for calculating an acceleration factor corresponding to the temperature value according to the temperature value and a preset temperature acceleration model;
a second calculation module configured for taking a product of the preset time period and the acceleration factor as a life cycle increment within the preset time period in the past; and
an update module configured for adding the life cycle increment to a retention time of target data so as to perform a storage area update on the target data in combination with a preset life cycle.

In an embodiment of the present disclosure, the first acquisition module is configured for:
acquiring the temperature value of the solid state disk SSD within the preset time period in the past in an SSD power-on state; and
the apparatus for calculating a data retention time further includes:
   a second acquisition module configured for acquiring a power-off time period of the solid state disk SSD; and
   a third calculation module configured for taking a product of the power-off time period and a preset acceleration factor as a life cycle increment within the power-off time period.

In an embodiment of the present disclosure, the first calculation module is used for executing the equation as follows:

$${T}_{A F} = \text{exp} {\left[\frac{{E}_{\text{a}}}{\text{k}} \left(\frac{1}{{T}_{\text{normal}}} - \frac{1}{{T}_{\text{stress}}}\right)\right]}_{;}$$

wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

To solve the above technical problem, the present disclosure also provides a device for calculating a data retention time, including:
a memory for storing a computer program;
a processor for implementing the steps of the method for calculating the data retention time as described in any of the above when executing the computer program.

According to the method for calculating a data retention time provided in the present disclosure, different temperature values are considered for different degrees of consuming a life cycle, and in the calculation of a retention time of target data in the present disclosure, an acceleration factor corresponding to the temperature value within the time period is multiplied with a time parameter. Since a time factor and a temperature factor are combined herein, the retention time derived from the calculation is more accurate, and a situation where the retention time does not reach a preset life cycle but data is erroneous is avoided, which improves the security of data storage.

The present disclosure also provides an apparatus and device for calculating a data retention time having the same advantageous effects as the above method for calculating a data retention time.

### BRIEF DESCRIPTION OF THE DRAWINGS

In order that the technical solutions of the embodiments of the present disclosure are explained more clearly, a brief description will be given below, the accompanying drawings of which are necessary for the prior art and the embodiments herein. It is apparent that the drawings in the following description are only some embodiments of the present disclosure, and it is conceivable for those of ordinary skill in the art to obtain other drawings based on these drawings without involving any inventive effort.

FIG. 1 is a flow chart illustrating a method for calculating a data retention time according to the present disclosure;

FIG. 2 is a schematic structural diagram of an apparatus for calculating a data retention time according to the present disclosure; and

FIG. 3 is a schematic structural diagram of a device for calculating a data retention time according to the present disclosure.

### DETAILED DESCRIPTION

It is an essence of the present disclosure to provide a method for calculating a data retention time, which may avoid the situation where the retention time does not reach a preset life cycle but the data is erroneous, and improve the security of data storage. Another essence of the present disclosure is to provide an apparatus and device for calculating data retention time, which may avoid the situation that the retention time does not reach the preset life cycle but the data is erroneous, and improve the security of data storage.

In order that the objects, aspects and advantages of the embodiments of the present disclosure will become more apparent, a more complete description of the embodiments of the present disclosure will be rendered by reference to the appended drawings, which are provided to illustrate, by way of example, some, but not all embodiments of the invention. Any other embodiments obtained on the basis of the embodiments of the present disclosure by a person of ordinary skill in the art without inventive efforts shall fall within the scope of the present disclosure.

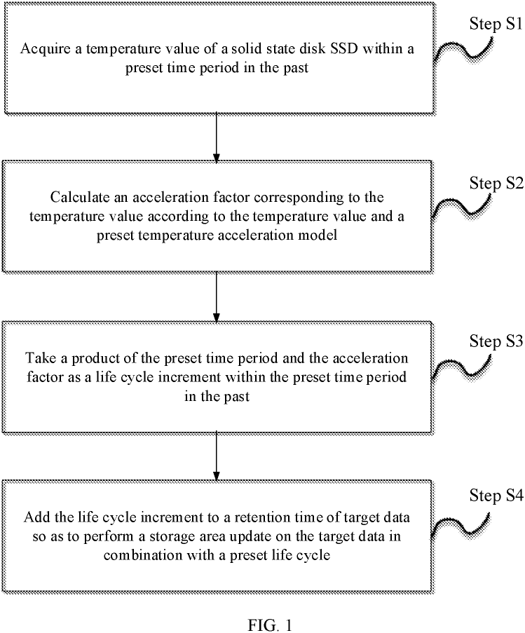

With reference to FIG. 1, a flow chart illustrating a method for calculating a data retention time according to the present disclosure, the method for calculating a data retention time includes the following steps.

In step S1, a temperature value of a solid state disk SSD within a preset time period in the past is acquired.

In some embodiments of the present disclosure, since the applicant considers that the aging speed of electronic components varies at different temperatures, and the corresponding life cycle of data stored in a computer flash memory device (NAND) of a solid state disk is similar to this; at a higher temperature, electrons show higher activity and are more likely to overflow, and the data stored in NAND is also more prone to damage; therefore, it is necessary to consider a temperature parameter when calculating and incrementing the retention time of data. In this step, the temperature value of SSD within a preset time period in the past may be obtained first as a data basis to calculate the retention time in the subsequent steps.

Herein, the preset time period may be set at will, for example, 15 seconds. The embodiments of the present disclosure do not limit in this regard.

In some embodiments of the present disclosure, the temperature value may be acquired in various ways, for example, the temperature value may be acquired by a temperature sensor arranged at a preset position of the SSD, and the temperature sensor may be either an original temperature sensor carried with the SSD or an additional temperature sensor, and the embodiments of the present disclosure are not limiting in this regard.

In step S2, an acceleration factor corresponding to the temperature value is calculated according to the temperature value and a preset temperature acceleration model.

In some embodiments of the present disclosure, although the temperature value affects the retention time, it is not possible to directly calculate the temperature value with the time, and to what degree different temperature values affect the retention time should be considered; therefore, in this step, a preset temperature acceleration model is introduced to calculate an acceleration factor corresponding to the temperature value; as readily understood, the acceleration factor indicates to what degree different temperature values accelerate the consumption rate of a life cycle, and the influence of the temperature value on the life cycle may be included into the calculation of the retention time in the subsequent steps with the acceleration factor.

Herein, the preset temperature acceleration model may be of various types and may be set at will, and embodiments of the present disclosure are not limiting in this regard.

In step S3, a product of the preset time period and the acceleration factor is taken as a life cycle increment within the preset time period in the past.

In some embodiments of the present disclosure, with the acceleration factor calculated in the previous step, the preset time period may be multiplied by the acceleration factor, so that the effect of the temperature value on the retention time may be included in the calculation of the retention time, and thus the calculation of the life cycle increment in the past preset time period is more accurate.

Herein, the life cycle increment may be defined as an increment of consumption of the life cycle of target data.

In some embodiments of the present disclosure, the product of the preset time period and the acceleration factor may be understood as converting the preset time period at different temperature values into a life cycle consumption time at a unified standard temperature value (a preset standard temperature value corresponding to the preset life cycle) and used for the incrementing calculation of the retention time.

In step S4, the life cycle increment is added to a retention time of target data so as to perform a storage area update on the target data in combination with a preset life cycle.

In some embodiments of the present disclosure, after a life cycle increment within a preset time period is obtained, by adding the life cycle increment within the preset time period to the retention time, the cumulative calculation of the retention time is completed. In the subsequent process, the storage area of the target data may be updated on the basis of the retention time in combination with the preset life cycle to prevent an error in the target data.

The present disclosure provides a method for calculating a data retention time. In consideration of various degrees to which different temperature values consume a life cycle, according to the present disclosure, for the calculation of a retention time of target data, an acceleration factor corresponding to the temperature value within the time period is multiplied by a time parameter. Since the present disclosure combines the time factor and a temperature factor, the calculated retention time is more accurate, and a situation where the retention time does not reach a preset life cycle but data is erroneous is avoided, which improves the security of data storage.

On the basis of the above embodiments,

In an embodiment herein, acquiring the temperature value of the solid state disk SSD within the preset time period in the past is:
acquiring the temperature value of the solid state disk SSD within the preset time period in the past in an SSD power-on state; and
before adding the life cycle increment to the retention time of target data, the method for calculating the data retention time further includes:
   acquiring a power-off time period of the solid state disk SSD; and
   taking a product of the power-off time period and a preset acceleration factor as a life cycle increment within the power-off time period.

In some embodiments of the present disclosure, generally in the prior art, the duration of continuous storage of target data is only accumulated and calculated in a power-on state of the SSD, although the power-off time period of the SSD is short in some application scenarios, the life cycle of electronic components is reduced in the power-off state, too, that is, the preset life cycle for data to be stored in a fixed storage area is also consumed; therefore, it is necessary to perform statistics on the storage duration in the power-off state, and on this basis the retention time of the target data is accumulated.

Herein, in general, when the SSD is powered off, the ambient temperature is not higher than the preset standard temperature of the SSD, hence the acceleration factor when the SSD is powered off may be regarded as the acceleration factor at the standard temperature, that is, the preset acceleration factor is 1; as such, it is unnecessary to measure the temperature value of the SSD in a powered off state, which saves the cost.

Here, both the life cycle increment in the power-on time period and the life cycle increment in the power-off time period need to be accumulated into the retention time of the target data to calculate a more accurate retention time.

In an embodiment herein, calculating an acceleration factor corresponding to the temperature value according to the temperature value and a preset temperature acceleration model is:

$${T}_{A F} = \text{exp} {\left[\frac{{E}_{\text{a}}}{\text{k}} \left(\frac{1}{{T}_{\text{normal}}} - \frac{1}{{T}_{\text{stress}}}\right)\right]}_{;}$$

wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

In some embodiments of the present disclosure, the temperature acceleration model in the embodiment of the present disclosure is an Arrhenius acceleration model, which is suitable for calculating the acceleration factor of temperature on the data storage life cycle in SSD, and may further improve the accuracy of the calculation of the retention time herein. The Boltzmann constant may In some embodiments of the present disclosure be 8.62*10-5.

Apparently, in addition to the Arrhenius acceleration model, other various models are possible as the preset temperature acceleration model, and the embodiment of the present disclosure is not limiting in this regard.

In an embodiment herein, acquiring the power-off time period of the SSD includes:
recording a power-off time when the SSD is powered off;
recording a power-on time when the SSD is powered on; and
calculating the power-off time period of the SSD according to the power-on time and the power-off time.

In some embodiments of the present disclosure, the implementer in the embodiment of the present disclosure may be various, for example, CPU of SSD, which may record the power-off time itself and derive the power-off time period in the power-off process by calculating the elapsed time period from the power-off time to the power-on time.

Herein, the power-off time and the power-on time may be determined according to Coordinated Universal Time (UTC), which may improve the accuracy of the calculation of the power-off time period and further improve the accuracy of the calculation of the retention time.

In an embodiment herein, acquiring the temperature value of the solid state disk SSD within the preset time period in the past is:

Taking a temperature value collected presently of the SSD as the temperature value of the SSD within the past preset time period.

In some embodiments of the present disclosure, since the temperature value of SSD does not fluctuate too much in a short period of time in general, taking the temperature value of SSD collected currently as the temperature value of SSD within the past preset time period may save many unnecessary sampling actions and calculation processes, which reduces the processing pressure and power consumption.

Apparently, in addition to the above-mentioned method, the temperature value of SSD within a preset time period in the past may be acquired through another process, and embodiments of the present disclosure are not limiting in this regard.

In an embodiment herein, after adding the life cycle increment to a retention time of target data, the method for calculating the data retention time further include:
determining whether a value of the preset life cycle minus the retention time is less than a preset safety value;
under a condition that the value of the preset life cycle minus the retention time is less than the preset safety value, executing a moving action on the target data and clearing the retention time of the target data; and
under a condition that the value of the preset life cycle minus the retention time is not less than the preset safety value, executing the step of acquiring the temperature value of the solid state disk SSD within the past preset time period.

In some embodiments of the present disclosure, a cyclic accumulation calculation of the retention time may be performed through the steps of the embodiment herein, wherein the initial value of the retention time may be zero.

Here, when the embodiment herein is applied to the CPU of SSD, it is possible to automatically calculate the retention time without human intervention, hence the human cost is minimal.

In some embodiments of the present disclosure, the preset safety value may be set at will, and the embodiment of the present disclosure is not limiting in this regard.

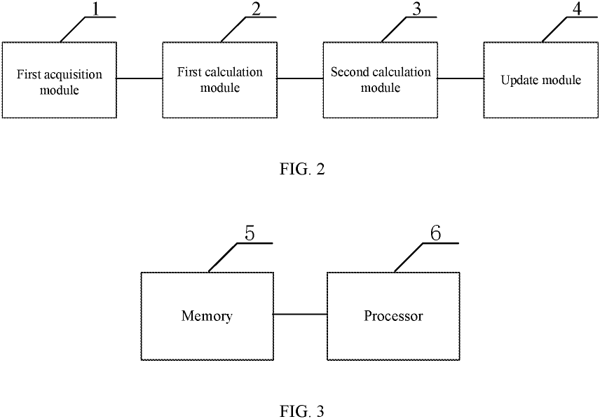

With reference to FIG. 2, a schematic structural diagram of an apparatus for calculating a data retention time according to the present disclosure, the apparatus for calculating a data retention time includes:
a first acquisition module 1 for acquiring a temperature value of a solid state disk SSD within a preset time period in the past;
a first calculation module 2 for calculating an acceleration factor corresponding to the temperature value according to the temperature value and a preset temperature acceleration model;
a second calculation module 3 for taking a product of the preset time period and the acceleration factor as a life cycle increment within the preset time period in the past; and
an update module 4 for adding the life cycle increment to a retention time of target data so as to perform a storage area update on the target data in combination with a preset life cycle.

In an embodiment herein, the first acquisition module 1 is used for:
acquiring the temperature value of the solid state disk SSD within the preset time period in the past in an SSD power-on state; and
the apparatus for calculating a data retention time further includes: a second acquisition module configured for acquiring a power-off time period of the SSD; and
a third calculation module configured for taking a product of the power-off time period and a preset acceleration factor as a life cycle increment within the power-off time period.

In an embodiment herein, the first calculation module 2 is used specially for the following equation:

$${T}_{A F} = \text{exp} {\left[\frac{{E}_{\text{a}}}{\text{k}} \left(\frac{1}{{T}_{\text{normal}}} - \frac{1}{{T}_{\text{stress}}}\right)\right]}_{;}$$

wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

Reference may be made to the aforementioned embodiments of the method for calculating a data retention time to understand an apparatus for calculating a data retention time according to an embodiment of the present disclosure, which will not be described in detail in the embodiment of the present disclosure.

With reference to FIG. 3, a schematic structural diagram of a device for calculating a data retention time according to the present disclosure, the device for calculating a data retention time includes:
a memory 5 for storing a computer program;
a processor 6 for implementing the steps of the method for calculating a data retention time described in the above embodiments when executing a computer program.

Reference may be made to the aforementioned embodiments of the method for calculating a data retention time to understand a device for calculating a data retention time according to an embodiment of the present disclosure, which will not be described in detail in the embodiment of the present disclosure.

Each embodiment in the specification is described in a progressive way. Each embodiment focuses on the differences from other embodiments. The same and similar parts between each embodiment may be seen in each other. For the device disclosed in the embodiment, because it corresponds to the method of open embodiment, the description is relatively simple, and the relevant places can be seen in the method section.

It should also be noted that the relational terms such as “first” and “second” in the present specification are used solely to distinguish one entity or operation from another entity or operation without necessarily requiring or implying any actual such relationship or order between such entities or operations. Furthermore, the terms like “include”, or any other variations thereof, are intended to indicate a non-exclusive inclusion, such that a process, method, article, or apparatus that includes a list of elements does not include only those elements but may include other elements not expressly listed or inherent to such process, method, article, or apparatus. An element defined by a phrase like “includes a ...” does not, without further constraints, preclude the existence of additional identical elements in the process, method, article, or apparatus that includes the element.

The above description of the embodiments disclosed enables a person skilled in the art may realize and use the present disclosure. Various modifications to these embodiments will be obvious to a person skilled in the art. The general principles defined herein may be realized in other embodiments without breaking away from the spirit or scope of the present disclosure. Therefore, the present disclosure will not be limited to these embodiments shown in this specification, but to conform to the widest range consistent with the principles and novel features disclosed in this specification.

1. A method for calculating a data retention time, comprising:
acquiring a temperature value of a solid state disk SSD within a preset time period in the past;
calculating an acceleration factor corresponding to the temperature value according to the temperature value and a preset temperature acceleration model;
taking a product of the preset time period and the acceleration factor as a life cycle increment within the preset time period in the past; and
adding the life cycle increment to a retention time of target data so as to perform a storage area update on the target data in combination with a preset life cycle.

2. The method for calculating a data retention time according to claim 1, wherein acquiring the temperature value of the solid state disk SSD within the preset time period in the past is:
acquiring the temperature value of the solid state disk SSD within the preset time period in the past in an SSD power-on state; and
before adding the life cycle increment to the retention time of target data, the method for calculating the data retention time further comprising:
acquiring a power-off time period of the solid state disk SSD; and
taking a product of the power-off time period and a preset acceleration factor as a life cycle increment within the power-off time period.

3. The method for calculating a data retention time according to claim 2, wherein calculating the acceleration factor corresponding to the temperature value according to the temperature value and a preset temperature acceleration model is:
$${T}_{A F} = exp \left[\frac{{E}_{\text{a}}}{\text{k}} \left(\frac{1}{{T}_{\text{normal}}} - \frac{1}{{T}_{\text{stress}}}\right)\right] ;$$
wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

4. The method for calculating a data retention time according to claim 2, wherein acquiring the power-off time period of the solid state disk SSD comprises:
recording a power-off time when the solid state disk SSD is powered off;
recording a power-on time when the solid state disk SSD is powered on; and
calculating the power-off time period of the solid state disk SSD according to the power-on time and the power-off time.

5. The method for calculating a data retention time according to claim 1, wherein acquiring the temperature value of the solid state disk SSD within the preset time period in the past is:
taking a temperature value collected presently of the solid state disk SSD as the temperature value of the solid state disk SSD within the past preset time period.

6. The method for calculating a data retention time according to claim 1, after adding the life cycle increment to the retention time of target data, the method for calculating the data retention time further comprising:
determining whether a value of the preset life cycle minus the retention time is less than a preset safety value;
under a condition that the value of the preset life cycle minus the retention time is less than the preset safety value, executing a moving action on the target data and clearing the retention time of the target data; and
under a condition that the value of the preset life cycle minus the retention time is not less than the preset safety value, executing the step of acquiring the temperature value of the solid state disk SSD within the past preset time period.

7. (canceled)

8. (canceled)

9. (canceled)

10. A device for calculating a data retention time, comprising:
a processor; and
a memory, storing a computer program that is executed by a processor, and upon execution by the processor, is configured to cause the processor to:
acquire a temperature value of a solid state disk SSD within a preset time period in the past;
calculate an acceleration factor corresponding to the temperature value according to the temperature value and a preset temperature acceleration model;
take a product of the preset time period and the acceleration factor as a life cycle increment within the preset time period in the past; and
add the life cycle increment to a retention time of target data so as to perform a storage area update on the target data in combination with a preset life cycle.

11. The device according to claim 10, wherein acquiring the temperature value of the solid state disk SSD within the preset time period in the past is:
acquiring the temperature value of the solid state disk SSD within the preset time period in the past in an SSD power-on state; and
before adding the life cycle increment to the retention time of target data, the method for calculating the data retention time further comprising:
acquiring a power-off time period of the solid state disk SSD; and
taking a product of the power-off time period and a preset acceleration factor as a life cycle increment within the power-off time period.

12. The device according to claim 11, wherein calculating the acceleration factor corresponding to the temperature value according to the temperature value and a preset temperature acceleration model is:
$${T}_{A F} = exp \left[\frac{{E}_{\text{a}}}{\text{k}} \left(\frac{1}{{T}_{\text{normal}}} - \frac{1}{{T}_{\text{stress}}}\right)\right] ;$$
wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

13. The device according to claim 11, wherein acquiring the power-off time period of the solid state disk SSD comprises:
recording a power-off time when the solid state disk SSD is powered off;
recording a power-on time when the solid state disk SSD is powered on; and
calculating the power-off time period of the solid state disk SSD according to the power-on time and the power-off time.

14. The device according to claim 10, wherein acquiring the temperature value of the solid state disk SSD within the preset time period in the past is:
taking a temperature value collected presently of the solid state disk SSD as the temperature value of the solid state disk SSD within the past preset time period.

15. The device according to claim 10, after adding the life cycle increment to the retention time of target data, the method for calculating the data retention time further comprising:
determining whether a value of the preset life cycle minus the retention time is less than a preset safety value;
under a condition that the value of the preset life cycle minus the retention time is less than the preset safety value, executing a moving action on the target data and clearing the retention time of the target data; and
under a condition that the value of the preset life cycle minus the retention time is not less than the preset safety value, executing the step of acquiring the temperature value of the solid state disk SSD within the past preset time period.

16. A non-transitory computer-readable storage medium, storing a computer program that is executed executable by a processor, and upon execution by the processor, is configured to cause the processor to implement operations as follows:
acquiring a temperature value of a solid state disk SSD within a preset time period in the past;
calculating an acceleration factor corresponding to the temperature value according to the temperature value and a preset temperature acceleration model;
taking a product of the preset time period and the acceleration factor as a life cycle increment within the preset time period in the past; and
adding the life cycle increment to a retention time of target data so as to perform a storage area update on the target data in combination with a preset life cycle.

17. The non-transitory computer-readable storage medium according to claim 16, wherein acquiring the temperature value of the solid state disk SSD within the preset time period in the past is:
acquiring the temperature value of the solid state disk SSD within the preset time period in the past in an SSD power-on state; and
before adding the life cycle increment to the retention time of target data, the method for calculating the data retention time further comprising:
acquiring a power-off time period of the solid state disk SSD; and
taking a product of the power-off time period and a preset acceleration factor as a life cycle increment within the power-off time period.

18. The non-transitory computer-readable storage medium according to claim 17, wherein calculating the acceleration factor corresponding to the temperature value according to the temperature value and a preset temperature acceleration model is:
$${T}_{A F} = exp \left[\frac{{E}_{\text{a}}}{\text{k}} \left(\frac{1}{{T}_{\text{normal}}} - \frac{1}{{T}_{\text{stress}}}\right)\right] ;$$
wherein T_{AF} is the retention time, Eₐ is 0.67, k is a Boltzmann constant, and Tₙₒᵣₘₐₗ is a preset standard temperature; when the temperature value is less than Tₙₒᵣₘₐₗ, Tₛₜᵣₑₛₛ is Tₙₒᵣₘₐₗ; when the temperature value is greater than Tₙₒᵣₘₐₗ and less than a preset threshold value, Tₛₜᵣₑₛₛ is the temperature value; when the temperature value is greater than the preset threshold value, Tₛₜᵣₑₛₛ is the preset threshold value.

19. The non-transitory computer-readable storage medium according to claim 17, wherein acquiring the power-off time period of the solid state disk SSD comprises:
recording a power-off time when the solid state disk SSD is powered off;
recording a power-on time when the solid state disk SSD is powered on; and
calculating the power-off time period of the solid state disk SSD according to the power-on time and the power-off time.

20. The non-transitory computer-readable storage medium according to claim 16, wherein acquiring the temperature value of the solid state disk SSD within the preset time period in the past is:
taking a temperature value collected presently of the solid state disk SSD as the temperature value of the solid state disk SSD within the past preset time period.

21. The non-transitory computer-readable storage medium according to claim 16, after adding the life cycle increment to the retention time of target data, the method for calculating the data retention time further comprising:
determining whether a value of the preset life cycle minus the retention time is less than a preset safety value;
under a condition that the value of the preset life cycle minus the retention time is less than the preset safety value, executing a moving action on the target data and clearing the retention time of the target data; and
under a condition that the value of the preset life cycle minus the retention time is not less than the preset safety value, executing the step of acquiring the temperature value of the solid state disk SSD within the past preset time period.

22. The non-transitory computer-readable storage medium according to claim 16, wherein the preset time period is 15 s.

23. The non-transitory computer-readable storage medium according to claim 16, wherein the life cycle increment is an increment of consumption of a life cycle of target data.
